(19) United States
(12) Patent Application Publication
(10) Pub. No.: US 2008/0035354 A1
(43) Pub. Date: Feb. 14, 2008

(54) WATER BASED FIRE EXTINGUISHERS

(76) Inventor: Peter Cordani, Palm Beach Gardens, FL (US)

Correspondence Address: McHale & Slavin, P.A., 2855 PGA Boulevard, Palm Beach Gardens, FL, 33410, US

(21) Appl. No.: 11/680,803

(22) Filed: Mar. 1, 2007

Related U.S. Application Data
(60) Provisional application No. 60/778,202, filed on Mar. 2, 2006.

(51) Int. Cl. A62C 2/00

(52) U.S. Cl. 169/14; 169/47

(57) ABSTRACT

The instant invention relates to a super absorbent polymeric material which when added to water enhances the fire extinguishing properties of the water. In particular, a pre-measured quantity of the polymeric material is added to a conventional water based canister capable of holding 2.5 gallons of pressurized water. The aqueous solution provides enhanced Class A & B fire extinguishing properties and is capable of long term storage.

### CROSS REFERENCE TO RELATED APPLICATIONS

This application claims the benefit of U.S. Provisional Application No. 60/778,202, entitled “Process for Fire Prevention and Extinguishing” filed on Mar. 2, 2006 the entire disclosure of which is herein incorporated by reference.

### FIELD OF THE INVENTION

This invention relates to a fire extinguishers and more particularly to use of a dehydrated super absorbent polymer to water in an amount sufficient to extinguish and prevent conflagrations.

### BACKGROUND OF THE INVENTION

Water has been known for its fire retardant and extinguishing properties for millennia and remains the predominate material used to extinguish or prevent certain types of fires. Water has a high heat capacity and high heat of vaporization, such that when water is sprayed onto a fire, the water that reaches the flames absorbs the heat of the fire and cools the article to below its combustion temperature. Water also deprives the fire of oxygen. Often the heat of the fire turns a portion of water into vapor before it can reach the flames. Since water vapor is heavier than air it displaces the oxygen surrounding the fire, thereby suffocating the fire.

A significant disadvantage often encountered using water to extinguish a fire is that much of it ends up wasted. Water applied directly to the fire mostly evaporates before it can reach the base of the fire, where the combustible fuel for the fire resides. As much as 90 to 95% of the water that does manage to reach the flames simply runs off into the ground. Moreover, considerable effort must be made to continuously soak objects with water near the fire that could ignite. In order to maintain protection of the objects from fire the evaporated water must be constantly replaced.

In many homes, offices and small businesses fire extinguishers comprising a container of water, which are pressurized, are employed. These fire extinguishers are relatively inexpensive and highly effective for extinguishing small fires. The fire extinguishers used in offices and small businesses are subject to regular inspections, usually yearly. During these inspections a significant problem has surfaced. The quantity of water in the fire extinguishers decreases due mainly to evaporation. The fire extinguishers must then be partially disassembled, water added and some must be re-pressurized.

U.S. Pat. No. 5,989,446 discloses a water additive for use in fire extinguishing and prevention. The additive comprises a cross-linked water-swellable polymer in a water/oil emulsion that is produced by an inverse phase polymerization reaction. The polymer particles are dispersed in an oil emulsion wherein the polymer particles are contained within discrete water “droplets” within the oil. With the help of an emulsifier, the water “droplets” are dispersed relatively evenly throughout the water/oil emulsion. This allows the additive to be introduced to the water supply in a liquid form, such that it can be easily educated with standard firefighting equipment. However, it has been observed that when this additive is placed in fire extinguishers which utilize a container of water, the mixture requires agitation every 15 days to prevent the polymer from settling out. Another problem with this additive is that it takes approximately 3-4 hours to “cure” such that it is able to absorb a sufficient amount of water and attain the viscosity necessary to adhere to vertical and horizontal surfaces for firefight purposes. Also, if the additive/water mixture is not completely flushed from a hose or nozzle after use, it will harden upon drying out and render the hose or nozzle useless.

U.S. Pat. No. 7,169,843 discloses absorptive, cross-linked polymers which are based on partly neutralized, monoethylenically unsaturated monomers carrying acid groups, and with improved properties, which has a high gel bed permeability and high centrifuge retention capacity.

U.S. Pat. No. 5,989,446 discloses prevention of the spread of fires and directly fighting fires, a cross-linked, water-swellable additive polymer in water/oil emulsion to be added to the firefighting water. The additive has the properties of absorbing large quantities of water, high viscosity for adherence to vertical and horizontal surfaces, and retention of sufficient fluidity. The method of adding this additive to the firefighting water by education or by a batch addition to the water source is also disclosed.

U.S. Pat. No. 5,190,110 discloses the fighting of fires or protection of objects from fire by applying thereto water, which comprises dispersing in the water particles of a cross-linked, water-insoluble but highly water-swellable acrylic acid derivative polymer in an amount insufficient to bring the viscosity above 100 mPa's. Advantageously, the particles are present in an amount such that after swelling the swollen particles hold 60 to 70% by weight of the total water, the polymer being a copolymer of an acrylic acid, the water containing silicic acid and/or a silicate as well as sodium, potassium or ammonium ions. The water is freely pumpable but the swollen particles adhere to surfaces they contact rather than running off rapidly.

U.S. Pat. No. 5,849,210 discloses a method of preventing or retarding a combustible object from burning including the steps of mixing water with a superabsorbent polymer (“SAP”) to form one at least partially hydrated SAP, and applying the at least partially hydrated SAP to the combustible object, before or after combustion. In another embodiment, an article of manufacture includes a SAP, that is prehydrated, is useful for preventing a combustible object from burning, or preventing penetration of extreme heat or fire to a firefighter or other animal.

U.S. Pat. No. 6,372,842 discloses methods of using an aqueous composition or dispersion containing a water-soluble or water-dispersible synthetic polymer, and compositions formed thereof. The aqueous composition or dispersion is added to agricultural spray, ink, deicing, latex paint, cleaner and fire-extinguishing chemical compositions, water-based hydraulic compositions, dust control compositions and so on, to impart properties including, but not limited to, aerosol control, shear stability, transfer efficiency, oil/water reduction, emollient performance, lubricity, thickening, and anti-wear capability, to the resultant composition formed thereof.

U.S. Pat. No. 5,087,513 discloses polybenzimidazole polymer/superabsorbent polymer articles. These articles are prepared by either mixing the superabsorbent polymer particulates with the polybenzimidazole polymer solution during the formation of the polybenzimidazole article, or forming a composite of a polybenzimidazole film or fiber material layer with a superabsorbent polymer particulate containing layer. These polybenzimidazole products absorb large amounts of fluid while retaining the flame retardancy and chemical unreactivity of conventional polybenzimidazole materials.

U.S. Pat. No. 4,978,460 discloses a particulate additive for water for fire fighting containing a strongly swelling water-insoluble high molecular weight polymer as gelatinizing agent, which comprises a water-soluble release agent which causes the particles of said gelatinizing agent not to swell, the particles of the gelatinizing agent being encased or dispersed in the release agent. Suitable release agents include polyethylene glycol, sugars, mannitol, etc. The gelatinizing agent may be a moderately cross-linked water-insoluble acrylic or methacrylic acid copolymer.

U.S. Pat. No. 5,519,088 discloses an aqueous gel comprising a polymer of (meth)acrylamide or particular (meth)acrylamide derivative(s), particulate metal oxide(s) and an aqueous medium, a process for producing said gel, and products utilizing said gel. This aqueous gel can be produced so as to have transparency, has fire resistance and can prevent the spreading of flames, and is highly elastic. The aqueous gel when produced transparent, becomes cloudy when heated or cooled and is useful for the shielding of heat rays or cold radiation.

Thus, what is lacking in the art is use of a non-toxic polymer that will increase the effectiveness of water for fire fighting that will not separate or impair the operation of a conventional water based fire extinguisher despite the length of time the mixture is stored.

### SUMMARY OF THE INVENTION

The instant invention discloses a process for retarding or extinguishing conflagrations using a superabsorbent polymer in water. The reaction of the water with the polymer creates a gel-like substance with a viscosity that allows the mixture to be readily pumped through a standardized 2.5 gallon water based fire extinguisher, yet viscous enough to cover vertical and horizontal surfaces to act as barrier to prevent fire from damaging such structures, minimizing the manpower need to continuously soak these structures.

The super absorbent polymer is capable of absorbing water up to several thousands times its own weight. These super absorbent polymers are prepared from water-soluble polymers, but have cross-linking structures that render the polymers water-insoluble. By taking water-soluble ethylenically unsaturated monomers which readily undergo vinyl polymerization, such as acrylamide, with cross-linking agents, a polymer can be produced that is of uniform small size, has a high gel capacity, is highly insoluble, but highly water-swellable (i.e., super absorbent polymer). The gel capacity refers to the property of the water-swollen polymer to resist viscosity changes as a result of mechanical working or milling.

The super absorbent polymers can be dehydrated to a powder. When the powder is added to an aqueous solution and agitated, a super absorbent gel-like substance is formed. In a dry state the preferred polymer may be considered a particle having a diameter less than 4000 microns but greater than 50 microns. In a swollen state the particle may have a diameter greater than three hundred times its weight (more surface area). In a totally water-swollen state, the particles contain up to 99.98 weight percent of water and as little as about 0.1 weight percent of polymer. Thus, such particles could hold from ten to thousands of times their own weight.

Without being bound by any particular theory of operation it is believed that the since the polymer particles are capable of absorbing water in significant quantities relative to its own weight, the water-swollen gel provides a greater water laden surface area, with a higher heat capacity, than the unbound water molecule. Thus, more water actually reaches the fire without being evaporated and therefore provides more cooling of the fire. Thus, the fire is extinguished using less water.

By way of example, it is well known that fire extinguishers can be filled with water or dry powders. As stated herein, water is extremely effective fire fighting composition and used in many buildings where conventional commercial enterprises take place. In fact, statistics indicate that around 90% of all fires are extinguished by the use of the conventional cylinders that employ a simple water mixture. The use of the polymer of the instant invention can simply be placed within a water based cylinder. As will be described later in this application, the amount of polymer is very small for the proper effectiveness. For instance, a typical cylinder which contains approximately 2.5 gallons of water would use approximately three ounces of the polymer. The polymer can be added directly to the water stored within the cylinder to allow for full saturation of the polymer before dispensing. Dispensing mechanisms need not be changed as the polymer, when absorbed with liquid, forms a near liquid state and will not cause clogging of valves, even on small cylinders. It should be noted that once the polymer has been dispensed, it is readily acceptable to absorb water from ancillary sources, such as other cylinders that are dispensing water, all of which helps maintains the moisture near the base of the fire. It has also been observed that after the polymer has been mixed with the water in the cylinder it remains in suspension and does not separate from the water for extended periods of time, i.e. years.

Accordingly, it is an objective of this invention to present a process for use with 2.5 gallon water based fire extinguisher that uses a super absorbent polymer that transforms water into a fire extinguishing or preventing substance or gel. This super absorbent polymer gel will bring fires under control more quickly, thus offering substantial water and timesaving.

Yet another objective of the instant invention is to provide a composition to fight fires that is non-toxic, biodegradable and non-hazardous. If the fire hazard addressed is outdoors, the gel-like substance helps the soil recover from fire by maintaining a higher moisture content of the soil for extended periods of time.

Another objective of the instant invention is to teach a composition for fighting fires that can be easily added to standard 2.5 gallon water based fire extinguishers for enhancing fire extinguishing of Class A fires and expanding the water based extinguisher to Class B fires.

A further objective of the invention is to provide a composition to fight fires that will remain in solution, subsequently to being mixed with water, for an extended period of time.

Still another objective of the instant invention is to teach pre-treating combustibles (e.g., people, foliage, structures) to preventing them from reaching their ignition temperature.

Yet another objective of the present invention is to teach a hydrated super absorbent polymer gel having a viscosity that allows the gel to be dispensed from a container reservoir without blocking the dispensing equipment.

Another objective of the instant invention is to teach a combination of water and super absorbent polymer having sufficient viscosity to enable it to cover and adhere to vertical and horizontal surfaces.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DRAWINGS

FIG. 1 illustrates a 2.5 gallon water based fire extinguisher.

### DETAILED DESCRIPTION

Detailed embodiments of the instant invention are disclosed herein, however, it is to be understood that the disclosed embodiments are merely exemplary of the invention, which may be embodied in various forms.

Therefore, specific functional and structural details disclosed herein are not to be interpreted as limiting, but merely as a basis for the claims and as a representative basis for teaching one skilled in the art to various employ the present invention in virtually any appropriately detailed structure.

The present invention relates to a composition for and process of retarding or extinguishing conflagrations using a super absorbent polymer in water in an amount sufficient to retard or extinguish the fire. The present invention utilizes biodegradable Asuper absorbent@ aqueous based polymers, for example, cross-linked modified polyacrylamides/potassium acrylate or polyacrylamides/sodium acrylate commercially available from Stockhausen, Inc. (Greenboro, N.C.). Other suitable polymers include, albeit not limited to, carboxy-methylcellulose, alginic acid, cross-linked starches, and cross-linked polyaminoacids.

In the present invention, a solid form of the super absorbent polymer, such as a powder, is introduced into a standard fire extinguishing canisters and water tanks and the mixture is agitated to disperse the powder. The resulting aqueous mixture of the super absorbent polymer and water have properties which enable the mixture to be sprayed onto and remain on vertical and horizontal surfaces of objects that are on fire. The adherence of the mixture to the surface of the object lowers the temperature of the object below the combustion temperature of the object, thereby extinguishing the fire.

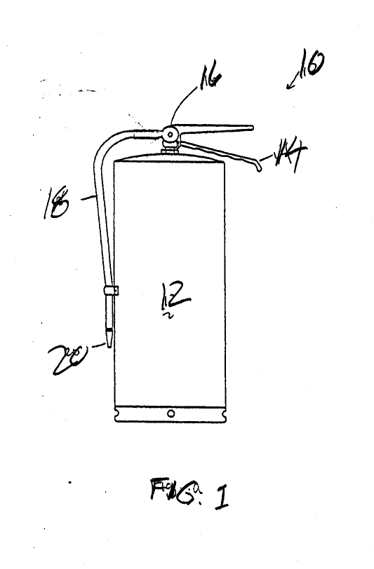

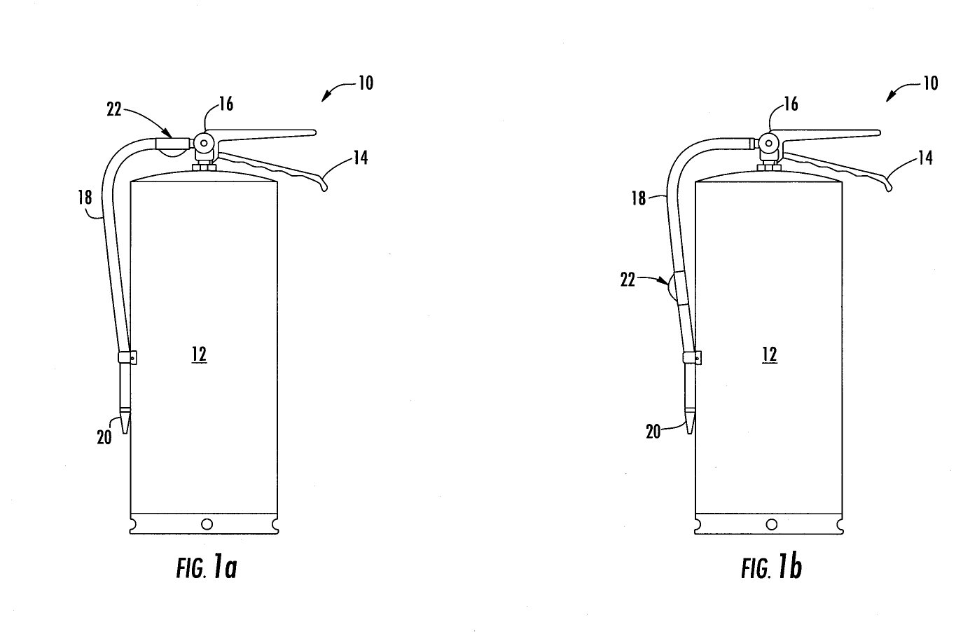

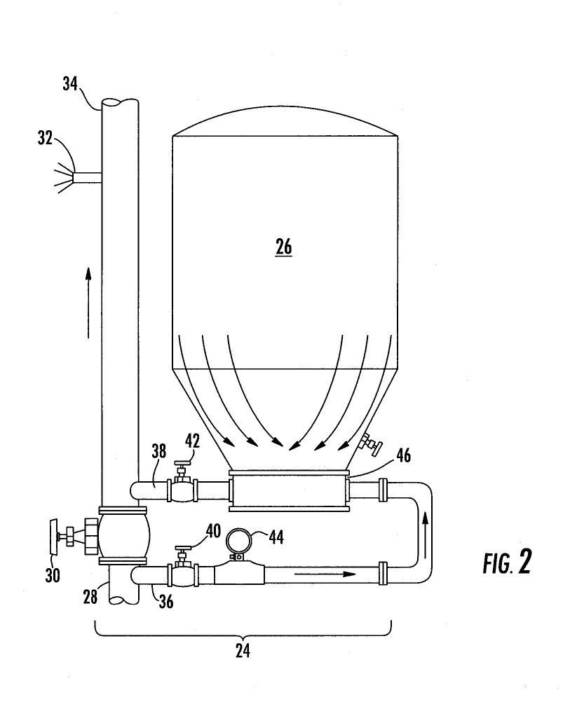

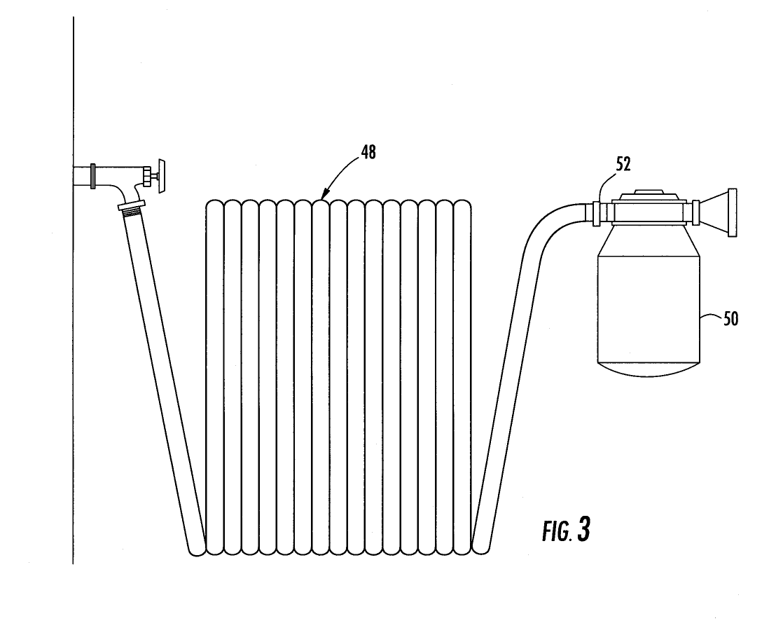

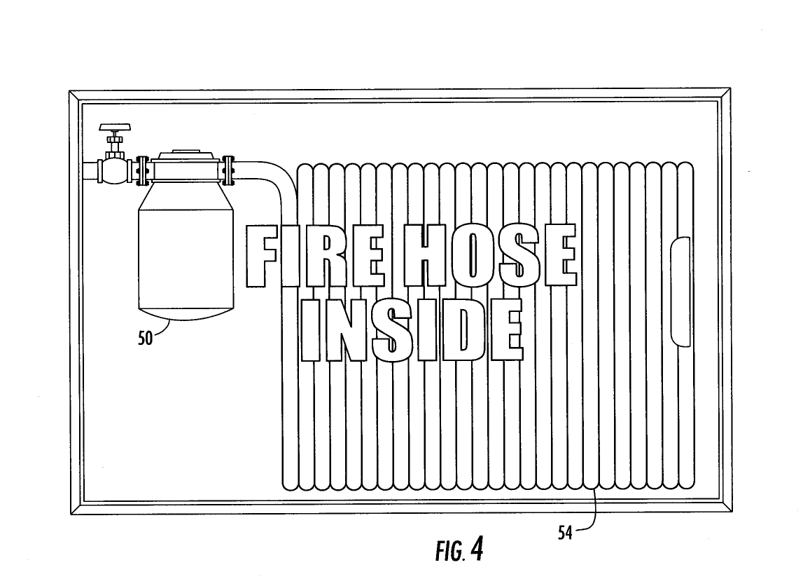

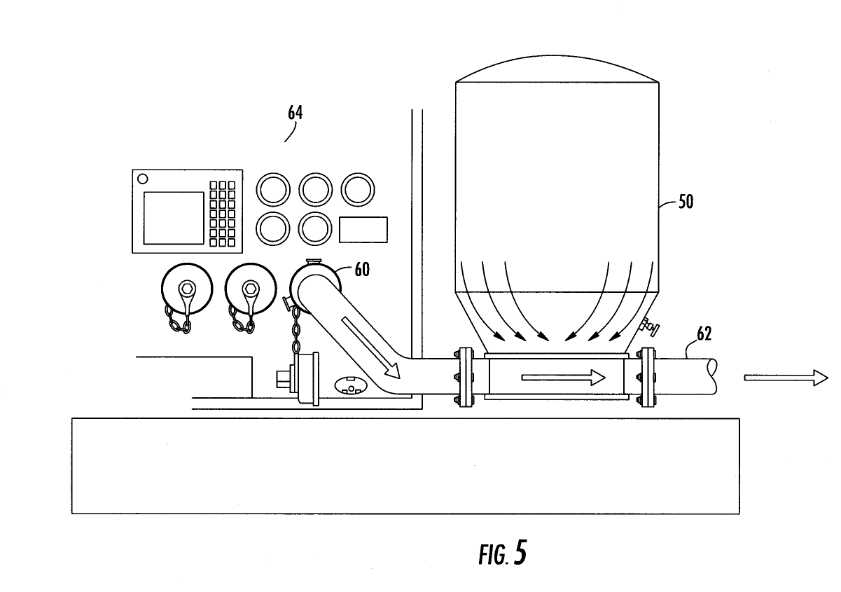

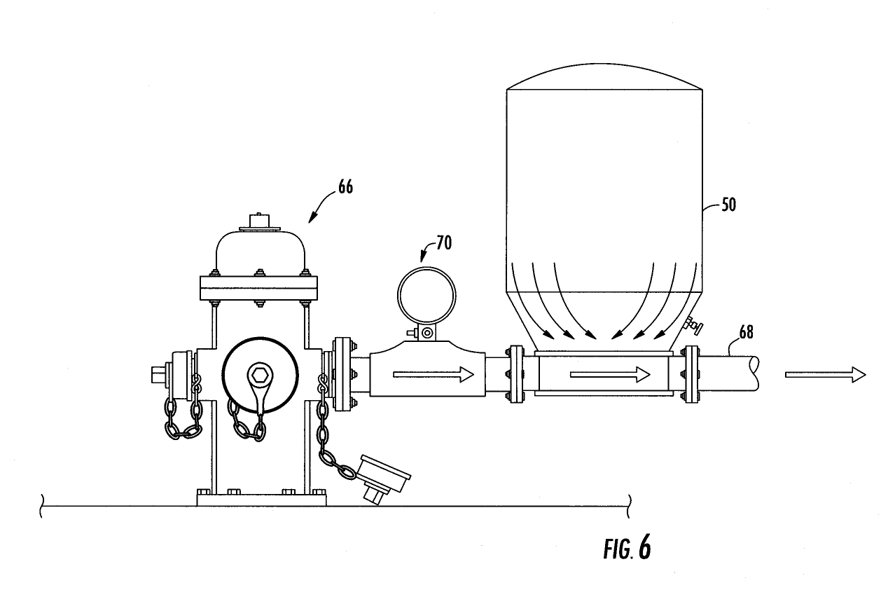

Referring now to the FIG. 1 wherein like elements are numbered consistently throughout, 10 illustrates a conventional hand-held water canister (i.e., water bomb) typically used to extinguish smaller fires. The canister is made of corrosion resistant material with a container body 12 used to store a predetermined volume of water therein. The capacity of the container is normally 2.5 gallons, but other sizes could also be utilized. The user dispenses the water by squeezing lever 14 that opens valve 16 allowing water and polymer in the container 12 to flow through a flexible hose 18 and out the nozzle portion 20. The user will then direct the flexible hose toward the base of the fire.

A given amount of powered super absorbent polymer is added to the water in the fire extinguishing canisters. The amount of powered super absorbent polymer used is in the range of about 2.2-3.7 ounces to 2.5 gallons of water and preferably 3 ounces to 2.5 gallons of water. The polymer can be added during the manufacturing process, prior to the canister being shipped to the user. Alternatively, the powered super absorbent polymer can be added to the fire extinguishing canister after the canister has been installed onsite at a building or home. To assist in determining the proper quantity of polymer a unit dosage pack is provided for the user or consumer. The unit dosage pack contains 2.2-3.7 ounces of polymeric material and preferably 3 ounces of polymeric material. To add the super absorbent polymer after the canister is onsite the user or consumer need only remove the valve assembly 16, add the powered polymer and re-pressurize the canister, if required. It has also been observed that the super absorbent polymer remains in suspension for extended periods of time, unlike the prior art polymers which fall out of suspension after only about six months. It is also contemplated that any of the aforementioned canisters may be of any size or shape deemed necessary to accommodate various needs and/or applications.

The instant invention operates as an improved method for extinguishing Class A and B fires by placing an effective amount of dehydrated super absorbent polymeric material into a freestanding canister sized to hold 2.5 gallons of water. Manufacturers of the 2.5 cannisters include: Badger-PW61; Amerex-B272NM; Firefox-FX100, FX300, FX400; Hazard Control Technologies-F500FE; Ansul; Pyro-Chem: Metalcraft; Williams Brothers; Traffic Safety & Equipment, and so forth. Each of these canister include the use of a disperser assembly securable to an open end of the canister. The canister is then filled with 2.5 gallons of water and the dispenser assembly is secured to the open end of the canister. The canister is pressurized according to the manufacturers procedures and pressure rating. The polymeric material admixes with the water to form an aqueous mixture whereby dispensing of the aqueous mixture results in lowering the combustion temperature of a burning object below the combustion temperature of the object.

### EXAMPLE

A non-limiting illustrative example is presented herein; the following is only an example and not solely representative of the inventive concepts discussed herein. To a 2.5 gallon canister approximately 3 ounces of a super absorbent aqueous based polymer was added and shaken vigorously for approximately 30 seconds. Within a few seconds the polymer obtained over 70% of its absorption capacity or nearly three hundred times its weight with water. The viscosity was such that the gel was able to be sprayed about 40 ft. and effectively cover most vertical and horizontal surfaces. It also adhered to the vertical and horizontal surfaces for an extended period of time. Moreover, the viscosity did not cause the polymer to aggregate or prevent discharge through the hose of the canister.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and drawings/figures. One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention. Although the invention has been described in connection with specific preferred embodiments, it should be understood that the invention should not be unduly limited to such specific embodiments.

What is claimed is:

1) An improved method for extinguishing Class A fires comprising: placing polymeric material into a freestanding canister sized to hold 2.5 gallons of water, said canister having a disperser assembly securable to an open end of said canister; inserting 2.5 gallons of water into said canister; securing said dispenser assembly to said open end of said canister; wherein said polymeric material admixes with said water forming an aqueous mixture whereby dispensing of said aqueous mixture results in lowering the combustion temperature of a burning object below the combustion temperature of the object.

2) The improved method for extinguishing fires according to claim 1 wherein said polymeric material is a dehydrated super absorbent polymer.

3) The improved method for extinguishing fires according to claim 1 wherein an effective amount of polymeric material is added to allow treatment of Class B fires.

4) The improved method for extinguishing fires according to claim 3 wherein said effective amount of polymeric material is between 2.2 and 3.7 ounces.

5) The improved method for extinguishing fires according to claim 3 wherein effective amount of polymeric material is about one ounce of polymer to one gallon of water.

6) The improved method for extinguishing fires according to claim 2 wherein said polymer is selected from the group consisting of cross-linked modified polyacrylamides, potassium acrylate, ployacrylamides, sodium acrylate carboxy-methylcellulose, alginic acid, cross-linked starches and cross-linked polyaminoacids.

7) The improved method for extinguishing fires according to claim 1 including the step of pressuring said aqueous mixture wherein said aqueous mixture is stored under pressure.

8) An improved method for extinguishing Class A and B fires comprising: placing and effective amount of dehydrated super absorbent polymeric material into a freestanding canister sized to hold 2.5 gallons of water, said canister having a disperser assembly securable to an open end of said canister; inserting 2.5 gallons of water into said canister; securing said dispenser assembly to said open end of said canister; pressurizing said canister to a rated pressure; wherein said polymeric material admixes with said water forming an aqueous mixture whereby dispensing of said aqueous mixture results in lowering the combustion temperature of a burning object below the combustion temperature of the object.

9) The improved method for extinguishing fires according to claim 8 wherein said effective amount of polymeric material is between 2.2 and 3.7 ounces.

10) The improved method for extinguishing fires according to claim 8 wherein said effective amount of polymeric material is about 3 ounces to 2.5 gallons of water.

11) The improved method for extinguishing fires according to claim 8 wherein said polymer is a cross-linked modified polyacrylamides/potassium acrylate.

12) The improved method for extinguishing fires according to claim 11 wherein said polymer is a cross-linked modified polyacrylamides/sodium acrylate.

13. A kit for inclusion within an existing water based 2.5 gallon fire extinguishing device comprising:
a unit dosage pack containing 2.2-3.7 ounces of a super absorbent polymeric material;
wherein addition of said unit dosage pack to provides a aqueous solution having optimum fire extinguishing properties.

14. A fire extinguishing kit comprising:
a container filled with about 2.5 gallons of water;
a dispenser assembly fluidly connected to an outlet of said container;
a unit dosage pack containing 2.2-3.7 ounces of a super absorbent polymeric material;
wherein the addition of said unit dosage pack to said water enables the polymeric material to combine with the water to enable the water, polymeric material mixture to attach to an object on fire thereby lowering the temperature of the object below the combustion temperature of the object.
